(19) United States
(12) Patent Application Publication
(10) Pub. No.: US 2019/0080322 A1
(43) Pub. Date: Mar. 14, 2019

(54) VIRTUAL CHECK SYSTEM AND METHOD

(71) Applicant: Strategic Engineering Group, LLC, Richmond, CA (US)

(72) Inventor: Victor Paul Elischer, Richmond, CA (US)

(21) Appl. No.: 16/128,189

(22) Filed: Sep. 11, 2018

Related U.S. Application Data
(63) Continuation of application No. 15/213,943, filed on Jul. 19, 2016, now abandoned.
Application No. 15/213,943 is a continuation of application No. 14/014,993, filed on Aug. 30, 2013, now abandoned.
(60) Provisional application No. 61/695,199, filed on Aug. 30, 2012.

(51) Int. Cl. G06Q 20/40; G07D 7/0043; G06Q 20/42; G06Q 20/04; G06Q 20/32; G06Q 20/02

(52) U.S. Cl. CPC G06Q 20/401; G07D 7/0043; G06Q 20/42; G06Q 20/40145; G06Q 20/3276; G06Q 20/023; G06Q 20/0425; G06Q 20/042

(57) ABSTRACT

This disclosure includes devices, systems, and methods for providing a virtual check blank. The virtual check blank includes data tags, including an issuer data tag, the issuer data tag including issuer check data and an issuer digital signature, and check image data configured to generate an image related to the virtual check blank and at least some of the data tags. The virtual check blank is configured to be modified by a payer in a transaction, wherein the virtual check blank is configured to add a payer data tag of the data tags, the payer data tag including: the issuer data tag, payer check data, a payer digital signature.

### PRIORITY

This application is a continuation of U.S. patent application Ser. No. 15/213,943, “VIRTUAL CHECK SYSTEM AND METHOD,” filed Jul. 19, 2016, which is a continuation of U.S. patent application Ser. No. 14/014,993, “VIRTUAL CHECK SYSTEM AND METHOD,” filed Aug. 30, 2013, which application claims priority to U.S. Provisional Application No. 61/695,199, “A VIRTUAL CHECK PAYMENT INSTRUMENT AND PAYMENT SYSTEM,” to Elischer, filed on Aug. 30, 2012, which application are incorporated by reference herein their entirety.

### TECHNICAL FIELD

The subject matter disclosed herein generally relates to a system and method for generating a virtual bank check.

### BACKGROUND

A conventional bank check may go through several steps over the course of a payment transaction. The check may be provided from the issuer of the check, such as a bank of a payer in the transaction, to the payer as a blank check printed on check stock with various security features. The payer may create a “payer check” by writing out the blank check to a specified payee, on a specified date, for a fixed, specified amount and signs the check to create the payment authorization. The payer may then transfer the payer check to the payee who may create a “payee check” by endorsing the check by signing the check on the back to acknowledge receipt of the payer check turn the payer check into a bearer negotiable cash item. The payee may then deposit the endorsed check into a bank that receives, and in turn endorses, the endorsed check on the back as a bank of first deposit (“BOFD”). The BOFD may then send the endorsed check as a cash item for collection to the payer's bank through the bank check clearing system. The check may be cleared as a paper item or converted to an image and cleared electronically, such as according to the Check 21 Standard.

### BRIEF DESCRIPTION OF THE DRAWINGS

Some embodiments are illustrated by way of example and not limitation in the figures of the accompanying drawings.

FIG. 1 is a block diagram of a system for generating a virtual check, in an example embodiment.

FIG. 2 is an abstract depiction of a data structure of a virtual check, in an example embodiment.

FIG. 3 is a block diagram of a registration service including a registration platform, in an example embodiment.

FIG. 4 is a block diagram of an issuing service including an issuing platform, in an example embodiment.

FIG. 5 is a block diagram of a payer service including a payer platform, in an example embodiment.

FIG. 6 is a block diagram of a payee service including a payee platform, in an example embodiment.

FIG. 7 is a deposit service including a deposit service provider, in an example embodiment.

FIGS. 8A-8E are depictions of facsimiles or graphic representations of the various stages of a virtual check, in an example embodiment.

FIG. 9 is a flowchart for generating a virtual check, in an example embodiment.

FIG. 10 is a block diagram illustrating components of a machine able to read instructions from a machine-readable medium, in an example embodiment.

### DETAILED DESCRIPTION

Example methods and systems are directed to a system and method for providing a virtual check. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Various methodologies have been developed for producing electronic or “virtual” bank checks. In one example, a blank paper check is scanned into a payer's computing device to provide an electronic image that may be manipulated. In another example, a payer may receive a cryptographically-secured memory device that contains information that allows the payer to create new checks and transmit the checks to the payee and other institutions based on cryptographic keys. Because such examples allow for the payer to create the checks in the first instance, the need for, for example, the payer's bank to issue blank checks to the payer is obviated.

However, such systems may not function without the use of cryptographic schemes and/or specialized hardware that protect the generated checks and the parties in the transaction. A party to the transaction that does not have the necessary cryptographic keys and/or specialized hardware or that is not otherwise part of the cryptographic system may not be able to participate in a transaction using such an electronic check. For instance, a payer may require specialized cryptographic hardware or have online access to cryptographic hardware to create an electronic check. As a result, such systems may, under various circumstances, be of relatively limited breadth. Additionally, the payer may be placed in a position of controlling and issuing checks, rather than the issuing bank controlling issuance of and knowing of the checks as issued and their associated serial number. The ability of entities other than the bank or an agent of the bank to issue checks may increase an occurrence of fraudulent checks being introduced to the system, owing in part to a lack of control by the bank in issuing the checks in the first instance.

A virtual check system and method has been developed that may obviate the need for specialized cryptographic hardware in the bank check transaction. In particular, in the virtual check system and method, a check blank may be generated and provided to the payer by an issuer, such as the payer's bank or the bank's issuing agent. The check blank may include an electronic journal that, analogous in certain respects to a conventional paper check, records the written results of participants at each of the steps of the payment transaction along with the correlated data entries of a virtual check service. The virtual check may progress though analogous state transitions brought on by the issuer and various parties to the transaction, such as the payer, the payee, and a deposit service for the bank of first deposit (BOFD). The written result of each state transition may be recorded in a separate component of the virtual check called a “data tag”, which each party to the transaction adding a new data tag to the virtual check, starting with the data tag of the issuer of the blank check.

In various examples, the data tags include information the same or similar to that which would be written on a conventional paper check in the equivalent state. The data tags may include additional information created by the system to provide added protection and/or security to the information. As a result, the contents of various ones of the data tags, and in an example each of the data tags, represent the written intention of the acting participant. A digital signature of the party may provide protection, at least in part, against alteration fraud and may finalize the involvement of the party in the transaction, potentially preventing subsequent repudiation of the check. The party digital signature may provide acknowledgement by the party of the state of the virtual check when received as well as new information added by the party. An optional digital signature of the service may operate as a witness to the transaction.

The virtual check may further include check image data that may render the virtual check as a print check facsimile. The print check may be generated based on the information in the tags and may be generated at various times during the transaction. For instance, the printed check may reflect the tag information, such as transaction information, from the issuer and the payer, i.e., the check has been filled out by the payer and is waiting for endorsement by the payee. The printed check may include a barcode that may include information included in the tags, such as transaction information, and signatures that have been added to the virtual check. Thus, in the above example, the barcode may also reflect the information from the issuer and the payer.

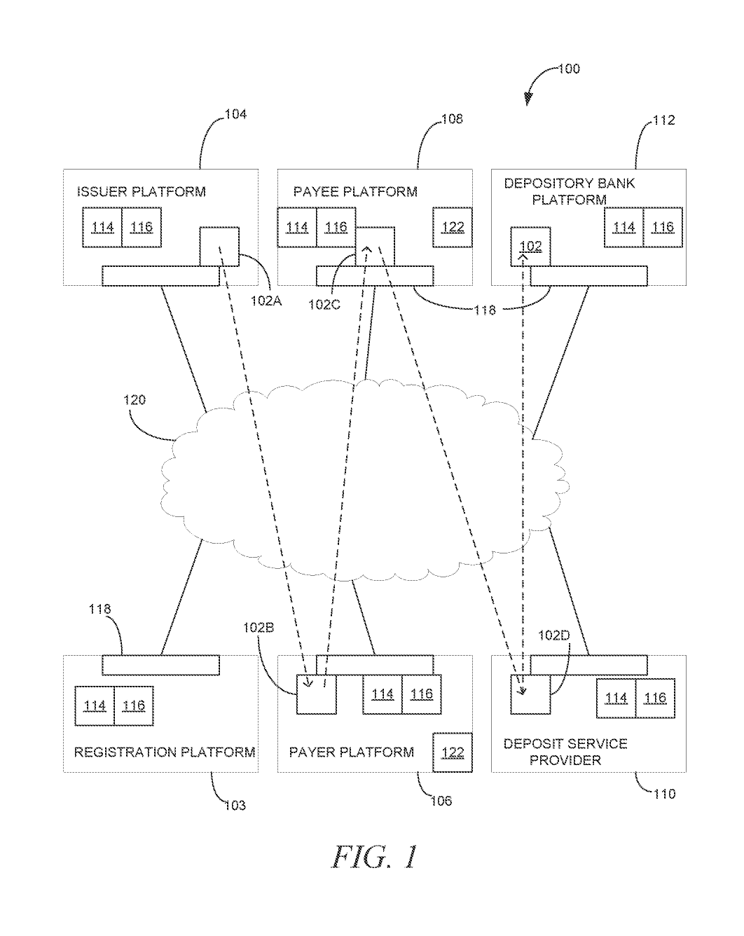

FIG. 1 is a block diagram of a system 100 for generating a virtual check 102. The system 100 optionally includes a registration platform 103, an issuer platform 104, a payer platform 106, a payee platform 108, a deposit service provider 110, and a depository bank platform 112 (collectively, the “platforms”). It is to be recognized and understood that various ones of the platforms 104, 106, 108, 110, 112 may or may not be included in the system 100 as a whole dependent on the particular circumstances of a transaction related to the virtual check 102. For instance, the system may only include the issuer platform 104, or may optionally further include the payer platform 106, whereupon the virtual check 102 may be printed and operate further as a conventional bank check outside of or in addition to the operation of the system 100.

The platforms 103, 104, 106, 108, 110, 112 may be implemented as conventional computing and/or networking equipment well known in the art. In an example, the issuer platform 104, the deposit service provider 110, and or the depository bank platform 112 may be servers as well known in the art while the payer platform 106 and the payee platform 108 may be personal computing systems, such as a personal computer, a tablet computer, a smartphone, a personal digital assistant (PDA), and the like. It is to be recognized and understood, however, that any of the platforms 103, 104, 106, 108, 110, 112 may be implemented as a server, personal computing equipment, or any other suitable equipment known in the art.

The platforms 103, 104, 106, 108, 110, 112 variously include a processor 114, electronic data storage 116, and a network interface 118. The processor 114 may be any of a variety of microprocessors, controllers, microcontrollers, and other processing devices known in the art. The electronic data storage 116 may be volatile memory, nonvolatile memory, hard drives, a variety of read-only memory (ROM), and other memory devices and storage devices and/or media. The network interface 118 of the various platforms 104, 106, 108, 110, 112 may permit communication over a network 120 according to a variety of network communication modalities, including wired and wireless modalities well known in the art.

The virtual check 102 progresses through the system 100 by transitioning to and among the platforms 104, 106, 108, 110, 112. The virtual check 102 is generated as a check blank 102A by the issuer platform 104 and then issued and transmitted to the payer platform 106. The payer platform 106 may create a payer check 102B by adding payer check data, such as an amount the check 102 is made out for, a date, and other data as disclosed herein. The payer platform 106 may then transmit the payer check 102B to the payee platform 108.

In various examples, the payee platform 108 may create a payee check 102C by endorsing the payer check 102B. The payee check 102C may be transmitted to the deposit service provider 110, which may create a deposit check 102D by endorsing the payee check 102C. The deposit check 102D may then be transmitted to the depository bank platform 112 to cause the transfer of funds, such as from an account associated with the payer to an account associated with the payee or according to the circumstances and requirements of the transaction, as may be the case.

### Data Structure

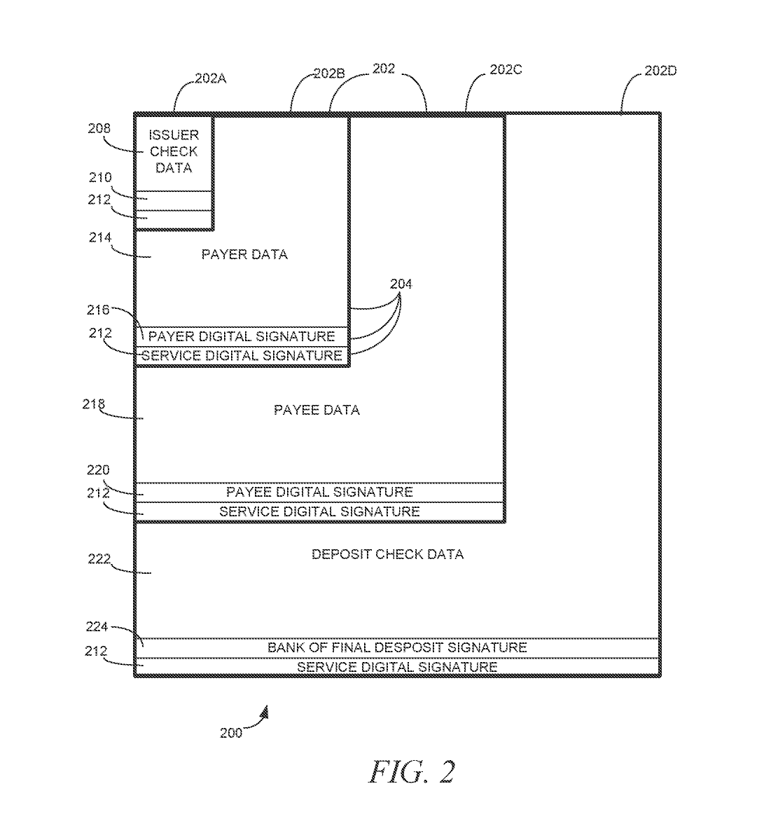

FIG. 2 is an abstract depiction of a data structure 200 of a virtual check 102. The data structure 200 may be created by the parties interacting with the virtual check services, such as may be shown in FIG. 1 and herein. It is to be understood that the creation of the various virtual checks 102 detailed above with respect to FIG. 1 may be achieved by an iterative process of adding additional data and signatures at each stage. Thus, the payee check 102C may be created by starting with the payer check 102B and adding the endorsement of the payee.

The data structure 200 includes nested data tags 202. Each data tag 202 includes multiple data tag fields 204. Certain fields 204 are consistent across the tags 202 while others are unique to their respective tags 202. As illustrated, each party to the transaction or electronic life of a particular virtual check 102 adds information to the virtual check 102 by incorporating a data tag 202 to the data structure 200.

The issuer of the virtual check 102, operating through the issuer platform 104, creates a check blank 102A for transmittal to the payer by way of the payer platform 106 by incorporating an issuer data tag 202A into the data structure 200. In an example, the issuer data tag 202A includes issuer check data 208, such as a serial number for the virtual check 102 and pertinent account numbers, and other information related to the creation of a check blank, such as the name of the issuing institution, a check template, an institutional logo or graphics, an institutional address, a routing transit number (RTN) fractional, a check MICR line, including the RTN, a customer account number, and the check serial number, a bank public key certificate, a bank authentication identification, additional bank authentication information. The issuer check data 208 may further include information related to the payer and/or the account associated with the payer, such as payer information as recorded and authenticated at registration with the issuer, a payer name, address, phone number, account number, payer logos or graphics, payer authentication information as captured by a registration service, a payer public key certificate, payer biometric data, and other information.

In various examples, the serial number is unique to the virtual check 102. In various examples, an issuing service or agent, such as the bank or an agent of the bank, assigns a unique serial number to each virtual check 102 and, optionally, notifies the bank of the account and serial numbers of the issued virtual checks 102. The bank may then validate a virtual check that moves through the system 100 as a virtual check 102 that has been properly issued, such as at the presentment of the virtual check 102 for redemption. In various examples, the serial numbers are ten (10) digits or longer. In conventional paper checks as well as physical representations of the virtual check 102, the last four (4) digits of the serial number may appear on a front of the check. In various examples, the issuer check data 208 includes check service information, an issuer service public key certificate, and other service related information. In an example, the issuer data tag 202A further includes an issuer digital signature 210 and a service digital signature 212, as disclosed herein.

In various examples, the digital signatures 210, 212, and other digital signatures disclosed herein, are ones of a variety of digital signatures known in the art. In an examples, the data structure 200 as built to the point of the inclusion of each digital signature 210, 212 is hashed to create a message digest, which is then encrypted using the private key of the sender (in this example, the issuer for the issuer digital signature 210 and the virtual check service 212 for the service digital signature 212). A plain-text message and the encrypted message digest may be sent to the receiving party (in this example, the payer or other receivers, as disclosed herein). The receive may decrypt the message digest using the public key of the sender, apply the hash algorithm to the plain-text data. If the results match, the authenticity of the sender and the integrity of the data structure 200 may be inferred. In various examples, the keys are from seven hundred sixty-eight (768) bits, one thousand twenty-four (1024) bits, two thousand forty-eight (2048) bits, and other values. Digital signature algorithms may be selected from proprietary examples or industry standards, such as RSA-MD5, RSA-SHA-1, RSA-SHA-256, RSA-SHA-384, and Digital Signature Architecture (DSA). Additional cryptographic techniques may be applied in the transmission of data tags 200, such as standard transport encryption methods like Secure Sockets Layer (SSL), Transport Layer Security (TLS), encrypted email, and others.

The payer data tag 202B includes, either in whole or in substantial part, the issuer data tag 202A, as well as payer check data 214, a payer digital signature 216, and the service digital signature 212. The payer check data 214 may include some or all of the payee name, a payee public key certificate where payee was registered by the system 100, the amount of currency the virtual check 102 is to be made out for, the date, a physical signature of the payer, payer authentication identifier (e.g., the payer public key), a memo text field, payer identity authentication information (e.g., payer biometric information, such as may be or may be compared against biometric information captured at the time of payment), a custom background image (e.g., a payee image, such as on a payee line, a payer image, such as on a signature line, or other optional background image), a virtual check 102 payer service public key certificate and/or other system 100 information, and digital signatures, including the payer's digital signature and a signature from the payer platform 106.

The payee data tag 202C includes, either in whole or in substantial part, the issuer data tag 202A and the payer data tag 202B, as well as payee check data 218, a payee digital signature 220, and the service digital signature 212. The payee check data 218 may include some or all of an endorsement signature provided by the payee, a payee authentication identification, such as they payee's public key, a restrictive endorsement message, payee authentication information (e.g., payee biometric information), a barcode, such as a two-dimensional barcode, as disclosed herein, and a virtual check 102 service public key.

The deposit data tag 202D includes, either in whole or in substantial part, the issuer data tag 202A, the payer data tag 202B, and the payee data tag 202C, as well as deposit check data 222, a bank of final deposit digital signature 224, and the service digital signature 212. The deposit check data 222 may include some or all of an encoded transaction currency amount, information related to the bank of first deposit generally, a bank of first deposit routing number, a return processing location, a date, a graphic and/or logo related to the bank, virtual check 102 service information, and the BOFD public key, among other potential information.

### Registration Service

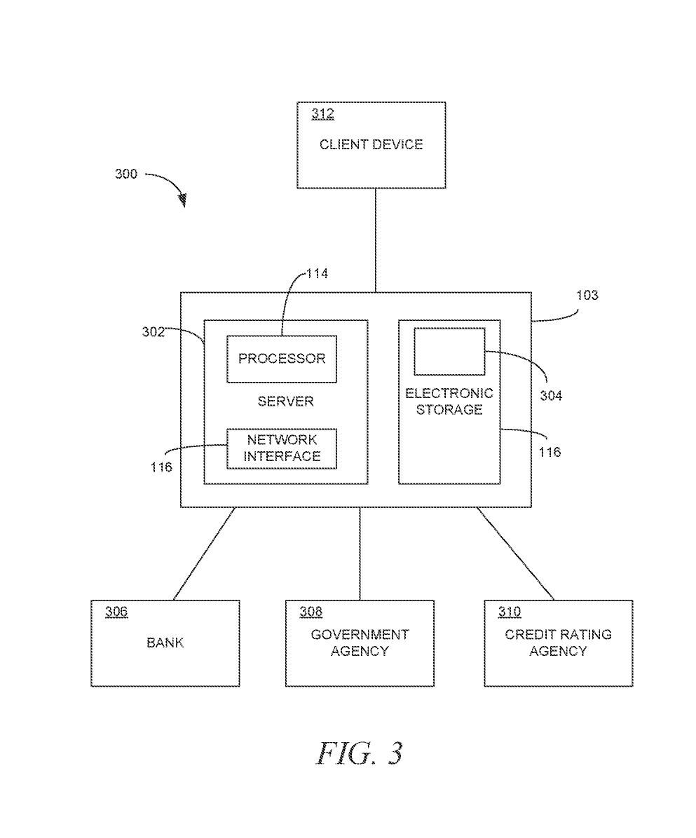

FIG. 3 is a block diagram of a registration service 300 including a registration platform 103. In various examples, the registration service 300 may sign up members for the virtual check service, validate the identities of the parties in the transaction and create cryptographic keys that are associated with each of the parties. The cryptographic keys may be conventional asymmetric public-private keys well known in the art or any other suitable cryptographic system. The registration service 300 may additionally associate each party with one or more of the payer's accounts and validate the payer's ownership of the accounts.

As illustrated, the registration platform 103 includes a registration server 302 incorporating the processor 114 and a network interface 118 as well as a database 304 on the electronic data storage 116. It is to be recognized and understood, however that the registration platform 103 may incorporate other components of the registration service 300 as disclosed herein.

The registration service 300 may include or may facilitate access between the registration platform 103 and a bank 306 or other financial institution, a government agency 308 or other public source of information, and/or a credit rating agency 310. The registration service 300 may further include or may facilitate access between the registration platform 103 and a client device 312, such as the payer platform 106 and the payee platform 108 or other device that may incorporate a user interface to obtain and display registration information.

The registration service 300 may obtain data related to users of the system 100. The registration service 300 may obtain and store in the database 304 some or all of a user name, address, phone number, email address, date of birth, birth place, social security number, photo identification, such as a driver's license, birth certificate, passport, tax information, bank account numbers, credit card numbers, mortgage loan numbers, utility bill accounts, and biometric data.

The registration service 300 may register parties with a demand deposit account (DDA) or other applicable account (collectively referred herein as a DDA account, though it is to be understood includes more than just DDA accounts). A payee may optionally not be registered and receive a payment from the virtual check 102 as a printed check, as disclosed herein. The registration service 300 may give each entity it registers a unique name and/or identification number within the system 100.

The registration service 300 may tend to establish an identity of a user of the system 100. The registration service 300 may verify a submitted identity against external sources, such as government agencies, 308, credit reporting agencies 310, public databases, phonebook address databases, public utilities, and other sources. The verification may cross reference personal data of the user, such as a name, address, bank account numbers, mortgage loans, credit card accounts, biometric data, and other identifiers as disclosed above, with public records.

The registration service 300 may establish an asymmetric key pair and register the public key certificate to the user, which may subsequently identify and authenticate the user. The public key may further be registered to one or more bank accounts or other accounts of or associated with the user. The private key may be transmitted to and stored, such as in secured storage, on a platform 104, 106, 108, 110 of the associated party or in another secure location. The public key may be published and made available within the system 100. The private key may be utilized to encrypt or digitally sign data tags 202, as disclosed herein. The public key may be associated with a DDA account corresponding to the party, and multiple public keys may be associated with a single DDA account (e.g., where an account has multiple parties who may access the account, such as each member of a married couple).

The registration service 300 may establish user attributes and/or user service preferences for transactions, generally, and with respect to virtual checks 102 in particular. The user attributes may include biometrics, challenge-response authentication metadata, other metadata, and other user attributes. The service preferences may include how the user would prefer to receive payments and how the user would prefer to be notified of a pending payment transaction. User attributes may specify limited rights to associated DDA accounts, such as limiting the right of the user to view an account or withdraw funds from the account.

The registration service 300 may register banks 306 or other financial institutions. Registration of banks 306 may include obtaining public information related to server certificates and routing numbers.

The database 304 may be encrypted for the storage of encryption keys and generated check blanks 102A and other checkbook documents as disclosed herein. The database 304 may further store biometric information, such as face images, fingerprints, iris images, DNA, and/or other biometric information.

### Issuing Service

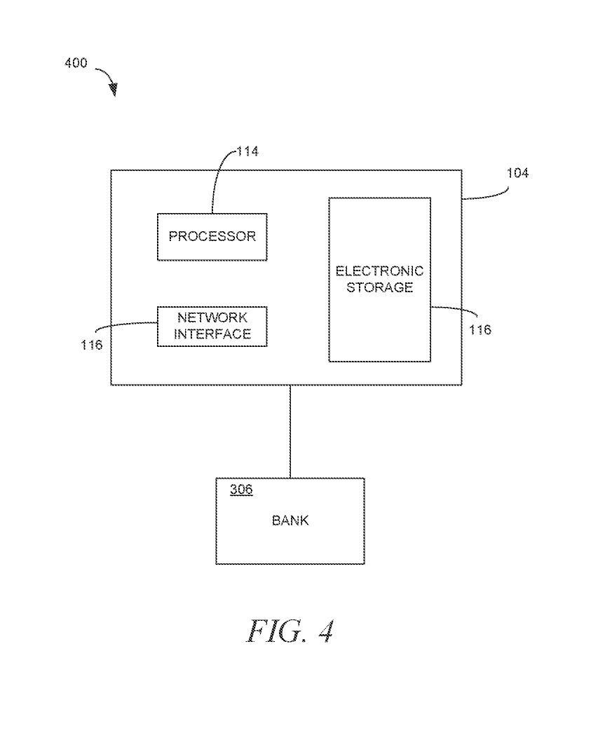

FIG. 4 is a block diagram of an issuing service 400 including the issuing platform 104. The issuing platform 104, and the issuing service 400 generally, may create the check blank 102A corresponding to a payer's DDA account, as well as other related documents, such as deposit slips and a check register. The issuing platform 104 may issue multiple check blanks 102A as a virtual checkbook. The check blanks 102A of a virtual checkbook may incorporate different, unique serial numbers as discussed in detail herein. The issuing platform 104, and the issuing service 400 generally, may be a subordinate agent to a bank 306 or other financial institution.

The virtual checkbook and/or individual virtual checks 102 may be provided to the payer on request or automatically. An order for a checkbook may include an account number and the name of the bank associated with the account. The payer may digitally sign a request with the payer's private key or may establish automatic issuance of the virtual checkbook and/or virtual checks 102 by providing the private key for future issuances. The issuing platform 104 may identify the user and decode the request with the public key of the user. The issuing platform 104 may then validate the user's identity against the database 304 of the registration service or against information that may have been obtained by the registration service 300 and provided to the issuing service 400. The issuing platform 104 may digitally sign the check blank 102A and the system 100 The issuing platform 104 may then transmit the blank check 102A, such as part of a virtual checkbook, and, optionally, a check register and serially-numbered check deposit slips.

The issuing platform 104, and the issuing service 400 generally, may generate the check blank 102A by including metadata for a graphic check template, print text, magnetic ink character recognition (MICR) text, logos, background images, and/or security watermarks. Such metadata may correspond to location information specifying where the metadata is to be positioned on a graphic representation of the virtual check 102. A user may select a particular check blank 102A template among multiple check blank 102A templates, such as users may conventionally select between and among multiple bank checks and designs.

Generated check blanks 102A may be further customized with biometric data. Such biometric data may include a facial image of the account holder, a fingerprint, an iris image, or a retinal scan. The account holder may optionally request for encryption of additional information included in the virtual check 102, such as account numbers and the like. The check blanks 102A may be transmitted to a client device 312, such as a payer device 106.

### Payer Service

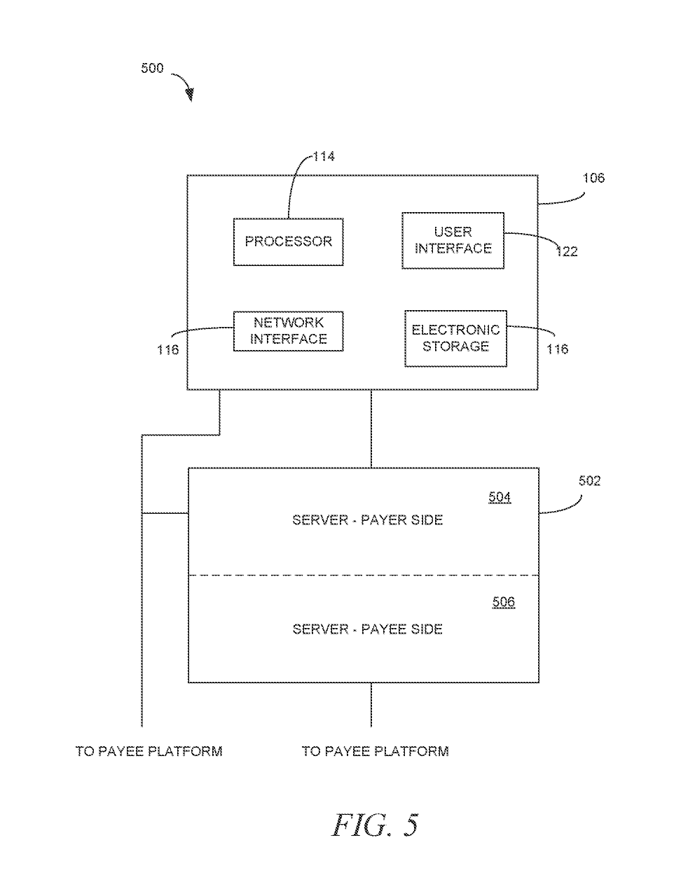

FIG. 5 is a block diagram of a payer service 500 including the payer platform 106. The payer platform 106, and the payer service 500 generally, may fetch and validate the check blank 102A and allow the payer to enter check data to create a payer check 102B, along with the payer's digital signature and, optionally, a facsimile of the payer's handwritten signature. The payer platform 106 may then transmit the payer check 102B to the payee platform 108.

The payer platform 106 may include a user interface 122, on which the payer may select and display the check blank 102A, such as from a virtual checkbook. The user interface 122 may be any of a variety of user interfaces well known in the art and may include a display and a user input device. The display may be or may include a liquid crystal display (LCD) or a light emitting diode (LED), among other displays, while the user input device may include some or all of a touchscreen, keyboard, mouse, trackball, and other related devices.

The payer may use the user interface 122 to write out the virtual check 102. In various examples, writing out the virtual check 102 may include entering the name of the payee, the date, the amount of the check, and the payer's written authorizing signature, as well as an optional memo field text. The entry of the data may be directly onto a visual representation of the virtual check 102, as disclosed herein, or into electronic data fields not graphically associated with a visual representation of the virtual check 102. This data may be stored with other data as part of a payer data tag, as disclosed herein.

The user interface 122 may be utilized to create a personalized or “vanity” check. For instance, personalized images, such as of family members, landscapes, buildings, and the like, may be incorporated to appear as background images or other semi-transparent renderings. Such images may be included in the issuer data tag 202A and/or the payer data tag 202B and may be sized and resolved to be appropriate to the size of a conventional check or may be of higher or lower size and resolution, as desired.

The payer check 102B having been created, the payer check 102B may be transmitted by the payer platform 106 to the payee platform 108. The payer platform 106 may transmit the payer check 102B according to the payee preferences as obtained by the registration service 300. For instance, the payer check 102B may be transmitted via email, social network message, a direct web service, a physical media (such as paper or an electronic media), and other methods. Each transmittal method may include an appropriate set of security protocols as known in the art.

If the payee is not previously registered, the payee may, in various examples, be prompted to register with the registration service 300. If the payee does not register the payer platform 106 may, in various examples, be utilized to cause the payer check 102B to be printed and physically sent to the payee.

The payer service 500 may optionally be a server 502 through which the payer platform 106 may communicate for providing the payer check 102B to the payee. In various example, some or all of the componentry of the server 502 is included as part of the payer platform 106 itself or outside of the context of a dedicated server 502. In various examples, a printer 504 may be utilized to create a hardcopy of the payer check 102B for transmittal to the payee by mail, courier, hand delivery, or other method. The payer check 102B may also be transmitted electronically, such as via email (e.g., secure email) and other methods disclosed herein. The server 502 may incorporate a payer service side 504 generally dedicated toward interacting with the payer platform 106 and a payee service side 506 generally dedicated toward interacting with the payee platform 108.

The server 502 may provide virtual check 102 services on the system level. Thus, in various examples, the service digital signature 212 may be provided at the server 502 at various stages of the formation of the virtual check 102. Alternatively or additionally, the service digital signature 212 may be provided to each platform 104, 106, 108, 110, 112 and included as appropriate.

### Payee Service

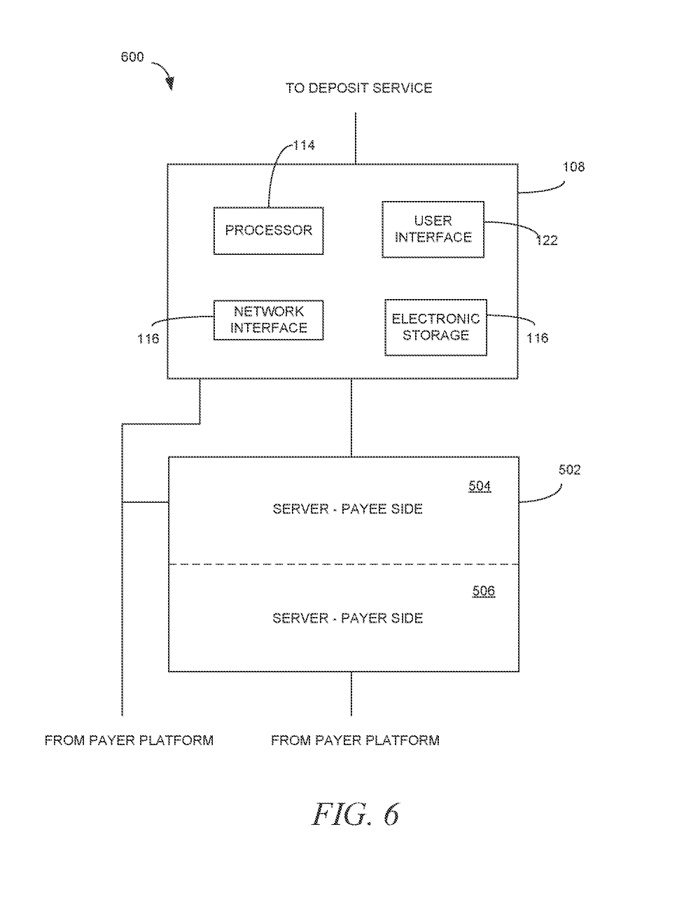

FIG. 6 is a block diagram of a payee service 600 including the payee platform 108. The payee service 600 generally, and the payee platform 108 specifically, may receive and validate the payer check 102B. The payee platform 108 may validate the issuer and, in various examples, the payer by cross referencing the corresponding digital signatures, as disclosed herein. The payee may be enabled thereby to enter payee data, such as a written signature and other information disclosed herein, as well as a digital signature to create the payee check 102C.

The payee platform 108 is optionally coupled to the server 502. The payee platform 108 may receive payer checks 102B via the server 502 or directly from the payer device 106. In various examples, as disclosed herein, the payer check 102B may be a physical check that may be manually delivered to the payee and bypass the payee platform 108 and server 502 altogether.

The payee platform 108 may obtain and display notification that a payer check 102B has been received, such as on a user interface 122 as disclosed above. Notification preferences may be defined with the registration service 300 and may include an email message, a text message, a social network message, a phone message or call, a physical package containing the payer check 102B, and other methods. The payee may utilize the user interface 122 to view the payer check 102B. The notification may inform the payee that a payment is pending and/or that the payer check 102B has been received. In various examples, the payer check 102B may not be delivered to the payee platform 108 or to the payee in general unless and until the payee utilizes the payee platform 108 to retrieve the payer check 102B.

The payee platform 108 may then be utilized to validate the payer check 102B by validating the data tags, as disclosed herein, to verify that the payer check 102B is based on a valid check blank 102A issued by a registered issuer to a registered payer of the issuing institution. Public keys of the issuer and the payer may be held online and accessed via the network 120 or may be stored locally on the payee platform 108, which may obviate a need for online access to validate the payer check 102B. The payer digital signature may additionally be validated with the registration service 300 and the system 100 generally. Additional aspects of the payer check 102B may be validated, including the amount of the check. Failure of a validation step may result in the payee personally or the payee platform 108 rejecting the payer check 102B, whereupon the payer check 102B may be voided and deleted or returned to the payer platform 106 for correction.

Validation may additionally or alternatively occur visually or biometrically. In an example, the payee platform 108 may display a graphic representation of the payer check 102B. In the event that, for instance, the payee platform 108 is not connected to a service configured to validate some or all of the digital signatures 210, 212, 214, the payee may, for instance, view the manual payment authorization signature of the payer or contact the payer directly to verify the payer check 102B and elect to accept the payer check 102B notwithstanding the lack of verification of the digital signatures 210, 212, 214. It is to be noted, however, that other components of the system 100 may, in certain examples, require subsequent verification of the digital signatures 210, 212, 214. Biometric verification may also substitute for a manual signature or a digital signature 210, 212, 214, according to methods disclosed herein.

The payee platform 108 may display a graphic representation of the virtual check 102, such as a representation of each of the front and the back of the virtual check 102, on the user interface 122. The payee may visually validate the payer's signature and decide whether to accept payment. The payee may then endorse the virtual check 102 via the user interface 122, such as by writing or typing an endorsement signature and an optional endorsement message (e.g., “For Deposit Only”). The endorsement data may appear on the back of the virtual check 102 as displayed. The payee platform 108 may then digitally sign the virtual check, which may, in part, provide the payee check 102C, as disclosed herein.

The payee may optionally select a mode of deposit for payment on the virtual check 102. Such modes may include: electronically submitting the virtual check 102 as disclosed herein; printing the virtual check 102 as a negotiable physical paper check which may then be deposited manually; and scanning the virtual check 102 and using a retail image deposit service.

### Deposit Service

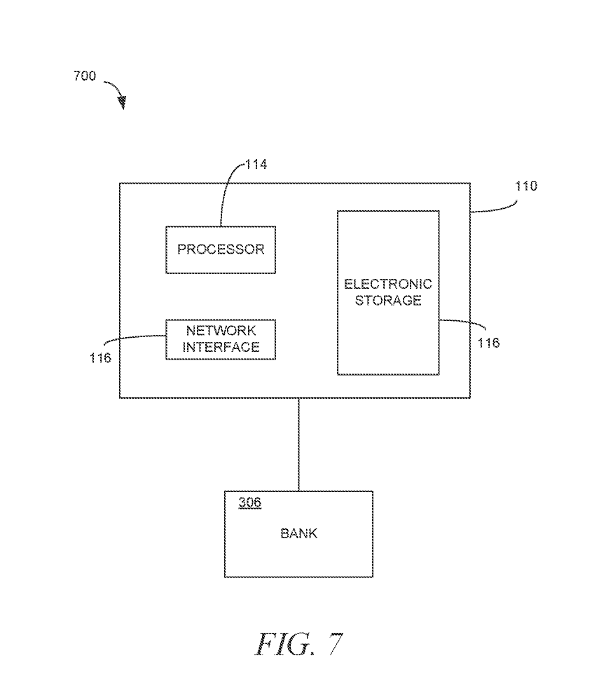

FIG. 7 is a deposit service 600 including the deposit service provider 110. The deposit service 600 generally may receive and validate the payee check 102C. The deposit service provider 110 may endorse the payee check 102C to create the deposit check 102D on the basis of the validation. The deposit service provider 110 may archive the deposit check 102D and, in various examples, prepare the deposit check 102D for image deposit, as disclosed herein, and witness the process step. A guarantee service, which may be independent of the deposit service, may convert the deposit check 102D to a guaranteed check that may be drawn on a pre-funded escrow DDA account.

The deposit service provider 110 may transform the payee check 102C into a format suitable for deposit to the payee's bank or financial institution. The deposit options include printing and depositing a physical copy of the virtual check 102 as a demand deposit, converting the virtual check 102 into a format compatible with the payee's bank or financial institution's image deposit protocol, converting the virtual check 102 into an image format and depositing it as part of an image cash letter for a wholesale customer, or converting the check to an automated clearinghouse (ACH) electronic deposit.

The deposit service provider 110 may retain a copy of the virtual check 102 as witnessed by a virtual check payment service in the event of payment disputes. Alternatively, the payer and the payee may retain and store a copy of the virtual check 102 as witness by the virtual check service. The digitally signed payment records may provide evidence for payment having been issued and received and that the virtual check 102 was not improperly altered. Remitters, wholesale, and retail providers may utilize an optional text memo field in the virtual check 102 to link their remittance advices or invoices to the virtual check 102 payment, such as may facilitate automated digital processing and posting of retail or wholesale receivables.

The deposit service provider 110, and the deposit service 600 generally, may add deposit information to the virtual check 102, such as may be related to a bank of first deposit of the virtual check 102. For instance, the deposit service provider 110 may incorporate deposit endorsement data and/or other data that may be required or otherwise desired by the bank of first deposit, such as a bank of first deposit endorsement stamp onto the graphic depiction of the virtual check 102. Such information may be included in the deposit data tag 202D. The deposit service provider 110 may further encode various aspects of the virtual check 102 to promote secure transmission of the virtual check 102 to the bank of first deposit.

Where the bank of first deposit does not receive electronic versions of the virtual check 102, the deposit service provider 110 may generate a graphical representation according to the requirements of the bank of first deposit. In various examples, the virtual check 102 may be graphically rendered according to known standards or according to specific requirements of the bank of first deposit. The deposit service provider 110 may also consult a database, such as may be available on the server 502 or elsewhere in the system 100, to verify that the virtual check 102 has not previously been deposited, such as by cross-referencing the serial number of the virtual check 102 against known transactions.

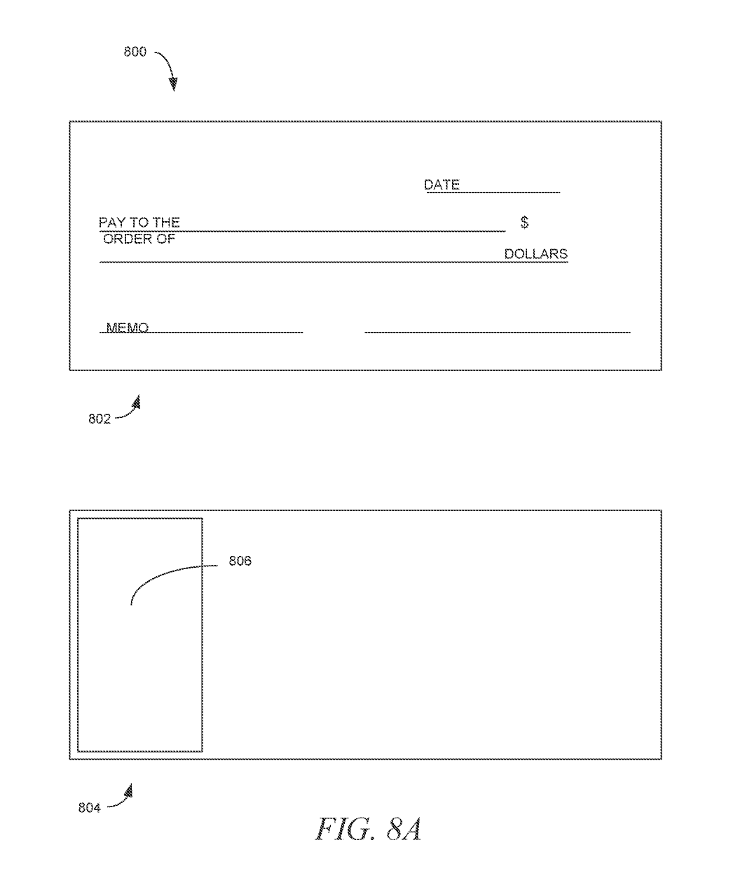

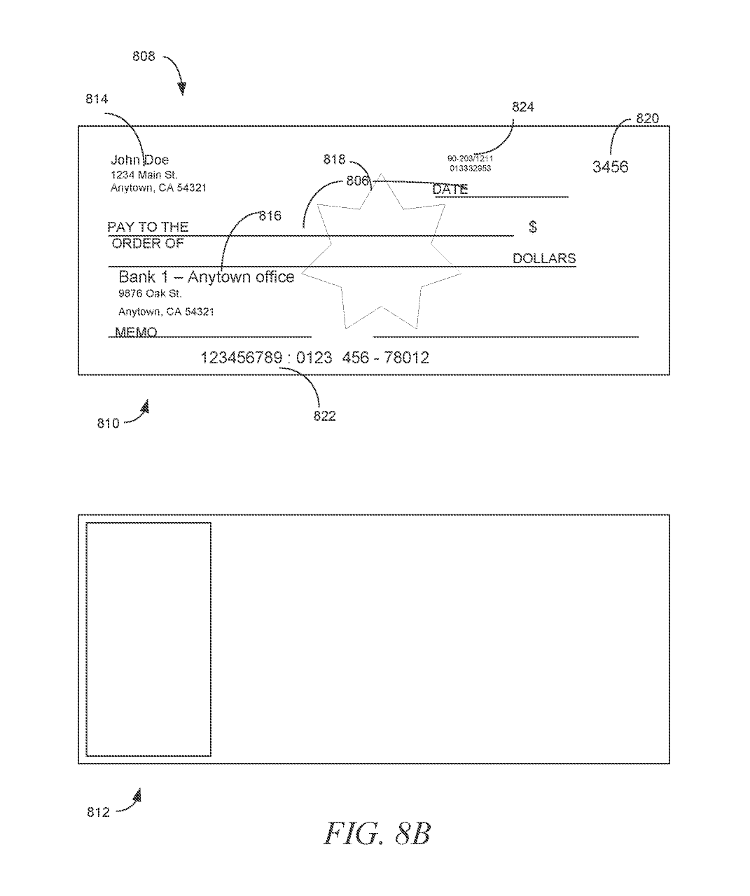

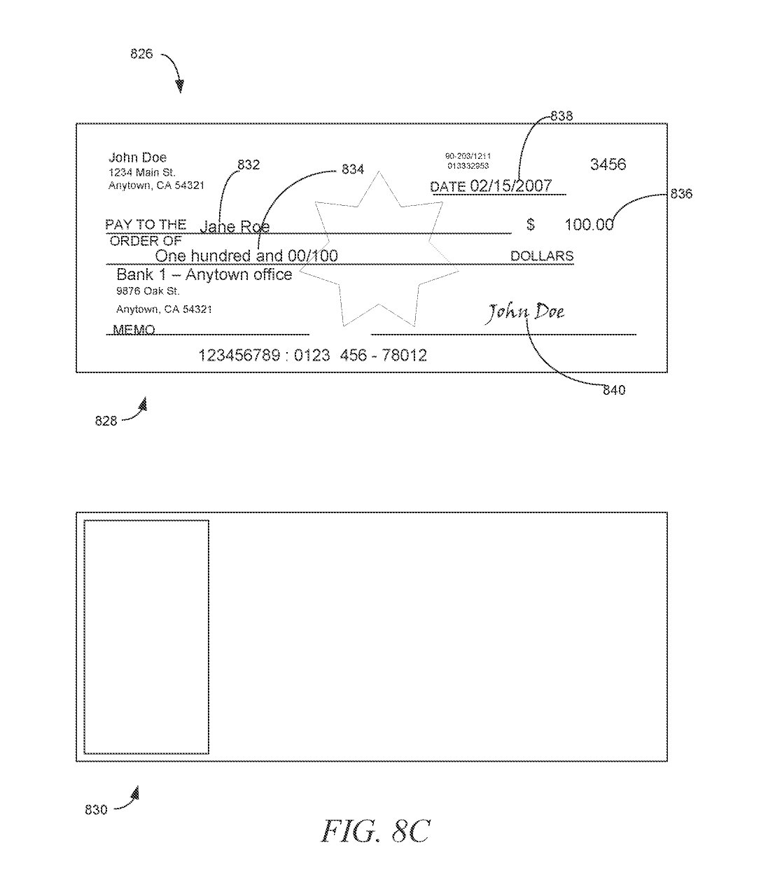

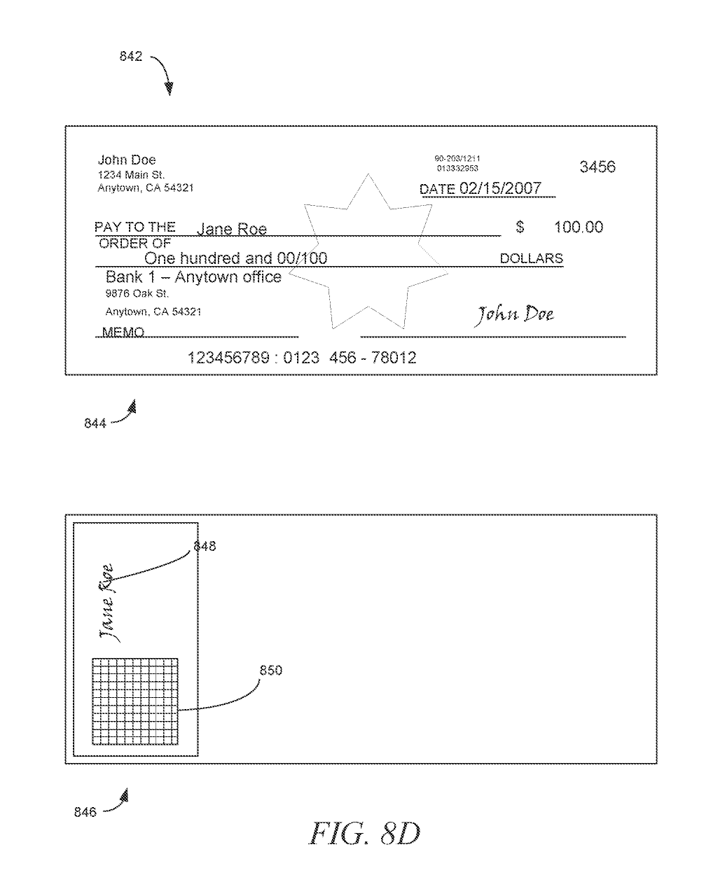

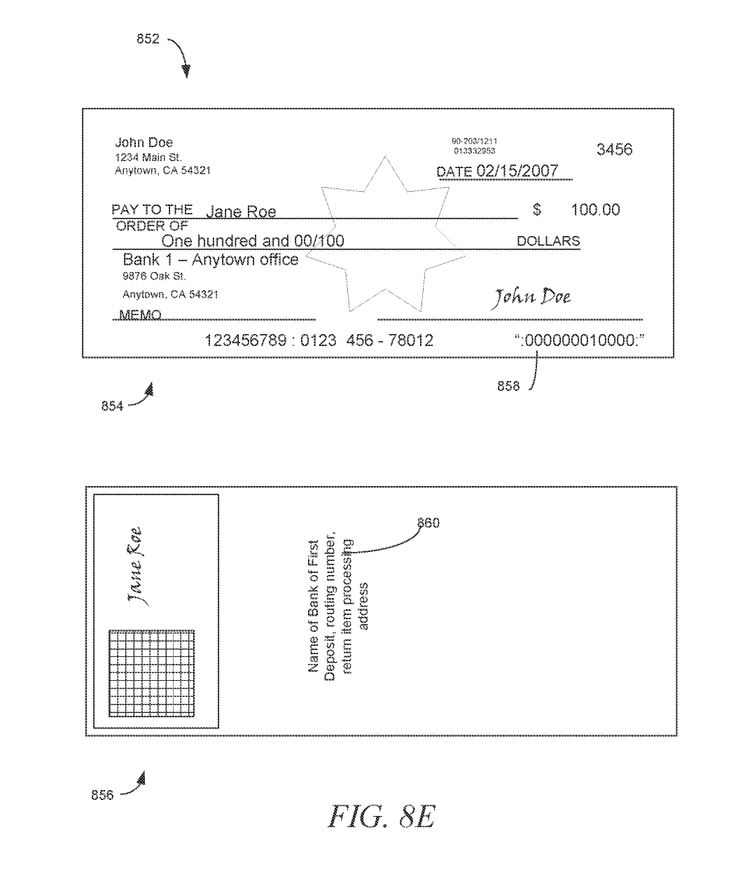

FIGS. 8A-8E are depictions of facsimiles or graphic representations of the various stages of the virtual check 102. The graphic representations may be displayed and optionally modified on the user interface 122 or may be printed as a physical check. As printed, the virtual check 102 may be treated as a conventional check for the purposes of completing the transaction.

FIG. 8A is a template 800 of the virtual check 102. The template 800 includes a front side 802 and a back side 804. The template 800 includes blanks 806 for filling out check information but no information that would tend to distinguish the template 800 and/or meet the requirements of a stage of the virtual check 102.

FIG. 8B is a graphic check blank 808 associated with the check blank 102A. The graphic check blank 808 includes a front side 810 and a back side 812. The back side 812 is unchanged or substantially unchanged from the back side 804 of the template 800. The front side 810 includes new information over the template 800, including a name and address of the payer 814, a name and address of an issuing bank 816, a watermark 818 of the issuing bank, a check number 820, an account or serial and routing number 822, and additional identification 824. Such information may be stored or reflected in the issuer data tag 202A. The watermark 818 may alternatively be or include a personalized image, such as may be related to a vanity check as disclosed herein.

In various examples, the account number and/or routing number 822 and other account numbers herein that may be visible on the physical rendering of the virtual check 102 may be a dummy account number, such as may be obtained by encrypting the actual account number, by generating or using an otherwise unrelated number, or by obscuring or otherwise omitting the account number 822. In such examples, the account numbers as stored in the data tags 200 and in the barcode (as disclosed herein) may reflect the actual account number of the virtual check 102, but information that would be visible to a human viewing a physical or graphical representation of the virtual check 102 may conceal the account number and/or routing number. In such examples, doing so may reduce a likelihood of the related account information being compromised through visual inspection of the virtual check 102.

FIG. 8C is a graphic payer check 826 associated with the payer check 102B. The graphic payer check 826 includes a front side 828 and a back side 830. The back side 830 is unchanged or substantially unchanged from the back side 812 of the graphic check blank 808. The front side 828 includes information incorporated by the payer, including the name of the payee 832, the amount of the check 834, 836, the date 838, and a signature 840. Such information may be stored or reflected in the payer data tag 202B. Optionally, a payer may incorporate one or more personalized images (e.g., a parent or grandparent may include a picture of a child or grandchild, such as for presentation to the child or grandchild or to others, an artist may incorporate a work of art by themselves or others, a property owner may incorporate an image of their property, etc.).

FIG. 8D is a graphic payee check 842 associated with the payee check 102C. The graphic payee check 842 includes a front side 844 and a back side 846. The front side 844 is unchanged or substantially unchanged from the front side 828 of the graphic payer check 826. The back side includes an endorsement 848 by the payee in the form of the payee's signature and, optionally, a barcode 850, such as a two-dimensional barcode or quick response (QR) code, that may encode data that has been added to the template 800, such as the data (e.g., essential transaction data) that is included in the data tags 202A, 202B, 202C. The additional information on the graphic payee check 842 may be stored or reflected in the payee data tag 202C.

The barcode 850 may be utilized to independently verify the information included in the graphic payee check 842 as well as in the data tags 202. It is to be recognized and understood that the barcode 850 may be included in any of the graphic checks 808, 826, 842 disclosed herein to encode check information and may be included on the front or back of the graphic check. The barcode 850 may optionally not be included.

FIG. 8E is a graphic deposit check 852 associated with the deposit check 102D. The graphic deposit check 852 includes a front side 854 and a back side 856. The front side 854 optionally includes a deposit number 858 (e.g., an amount of currency, such as in pennies, as read and encoded from the virtual check 102 or check in general) added in addition to information on the front side 844 of the graphic payee check 842. The back side 856 includes routing information 860 for the bank of first deposit in addition to the information on the back side 846 of the graphic payee check 842. The additional information may be stored or reflected in the deposit data tag 202D.

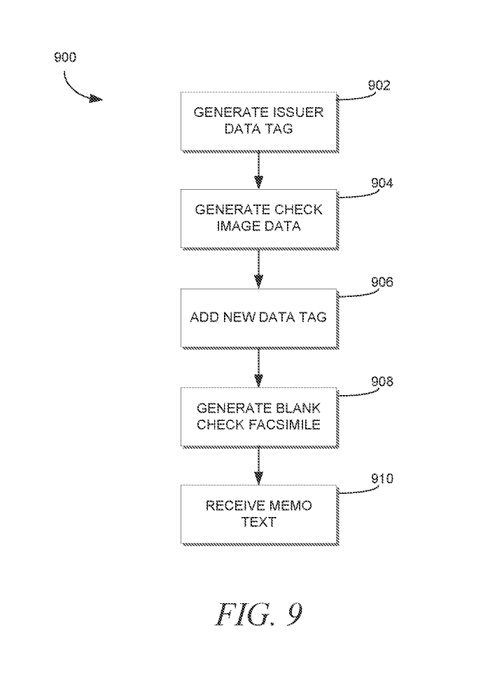

FIG. 9 is a flowchart 900 for generating a virtual check.

At 902, an issuer data tag of a virtual check blank is generated. The issuer data tag optionally includes issuer check data and an issuer digital signature.

At 904, check image data is generated. The check image data may be configured to generate an image related to the virtual check blank and at least some of the issuer data tags. The virtual check blank is configured to add a payer data tag as one of a plurality of data tags, the plurality of data tags including the issuer data tag upon adding the payer data tag, the payer data tag including: the issuer data tag, payer check data, a payer digital signature. In an example, at least one of the issuer data tag and the payer data tag further includes a service digital signature.

At 906, a new data tag to the plurality of data tags for each additional party to the transaction. The new data tag optionally includes each previously included data tag, additional party check data and an additional party digital signature. In an example, the at least one additional party includes a payee.

At 908, a bank check facsimile is generated based on the data tags. The bank check facsimile optionally includes a check amount, a date, a payer signature, a payee endorsement, and a barcode comprising at least some of the issuer check data and the payer check data, the issuer digital signature, the payer digital signature, and a payee digital signature. Generating the bank check facsimile optionally includes generating a first major side and a second major side of the blank check facsimile, the first major side including the check amount, the date, and the payer signature, and the second major side including the payee endorsement and the barcode. In an example, the issuer check data includes an account number associated with the check and generating the bank check facsimile includes displaying, on the blank bank check facsimile, a dummy account number different than the account number. In an example, a personalized image is included in the check image data.

At 910, memo text is received in a memo field related to the payer check data via a user interface.

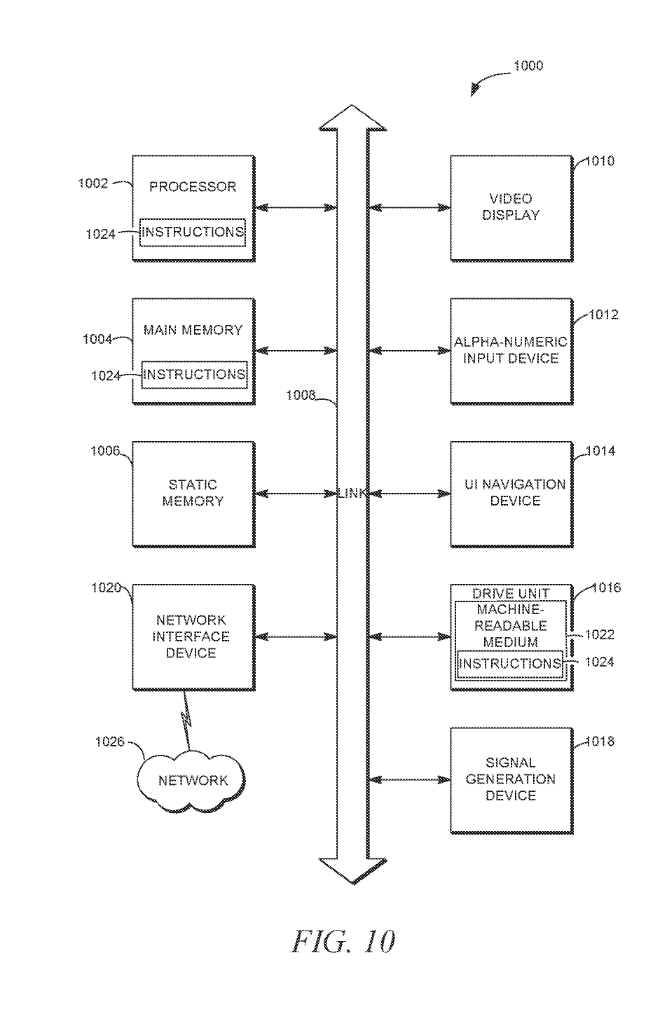

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system and within which instructions 1024 (e.g., software) for causing the machine 1000 to perform any one or more of the methodologies discussed herein may be executed. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a peer-to-peer (or distributed) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include a collection of machines that individually or jointly execute the instructions 1024 to perform any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a light emitting diode (LED) display, a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 (e.g., software) embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 via the network interface device 1020.

### Additional Examples

In Example 1, a computer readable medium is configured to store computer instructions which, when implemented on a processor, provide a virtual check blank, comprising data tags, including an issuer data tag, the issuer data tag including: issuer check data and an issuer digital signature, and check image data configured to generate an image related to the virtual check blank and at least some of the data tags. The virtual check blank is configured to be modified by a payer in a transaction, wherein the virtual check blank is configured to add a payer data tag of the data tags, the payer data tag including: the issuer data tag, payer check data, a payer digital signature.

In Example 2, the computer readable medium of Example 1 optionally further includes that the virtual check blank is further configured to be modified by at least one additional party to the transaction, wherein the virtual check blank is configured to add a new data tag for each additional party to the transaction, the new data tag including: each previously included data tag, additional party check data and an additional party digital signature.

In Example 3, the computer readable medium of any one or more of Examples 1 and 2 optionally further includes that the at least one additional party includes a payee.

In Example 4, the computer readable medium of any one or more of Examples 1-3 optionally further includes that the check image data is configured to generate a bank check facsimile based on the data tags, including a check amount, a date, a payer signature, a payee endorsement, and a barcode comprising at least some of the issuer check data and the payer check data, the issuer digital signature, the payer digital signature, and a payee digital signature.

In Example 5, the computer readable medium of any one or more of Examples 1-4 optionally further includes that the bank check facsimile has a first major side and a second major side, the first major side including the check amount, the date, and the payer signature, and the second major side including the payee endorsement and the barcode.

In Example 6, the computer readable medium of any one or more of Examples 1-5 optionally further includes that the payer check data further includes a memo field configured to receive memo text.

In Example 7, the computer readable medium of any one or more of Examples 1-6 optionally further includes that the check image data is configured to generate a blank bank check facsimile.

In Example 8, the computer readable medium of any one or more of Examples 1-7 optionally further includes that the issuer check data includes an account number associated with the check and wherein the check image data is configured to display, on the blank bank check facsimile, a dummy account number different than the account number.

In Example 9, the computer readable medium of any one or more of Examples 1-8 optionally further includes that the check image data includes a personalized image.

In Example 10, the computer readable medium of any one or more of Examples 1-9 optionally further includes that at least one of the issuer data tag and the payer data tag further includes a service digital signature.

In Example 11, a method includes generating an issuer data tag of a virtual check blank, the issuer data tag including: issuer check data and an issuer digital signature and generating check image data configured to generate an image related to the virtual check blank and at least some of the issuer data tags. The virtual check blank is configured to be modified by a payer in a transaction and the virtual check blank is configured to add a payer data tag as one of a plurality of data tags, the plurality of data tags including the issuer data tag upon adding the payer data tag, the payer data tag including: the issuer data tag, payer check data, a payer digital signature.

In Example 12, the method of Example 11 optionally further includes that the virtual check blank is further configured to be modified by at least one additional party to the transaction, and further includes adding a new data tag to the plurality of data tags for each additional party to the transaction, the new data tag including: each previously included data tag, additional party check data and an additional party digital signature.

In Example 13, the method of any one or more of Examples 11 and 12 optionally further includes that the at least one additional party includes a payee.

In Example 14, the method of any one or more of Examples 11-13 optionally further includes generating a bank check facsimile based on the data tags, including a check amount, a date, a payer signature, a payee endorsement, and a barcode comprising at least some of the issuer check data and the payer check data, the issuer digital signature, the payer digital signature, and a payee digital signature.

In Example 15, the method of any one or more of Examples 11-14 optionally further includes that generating the bank check facsimile includes generating a first major side and a second major side of the blank check facsimile, the first major side including the check amount, the date, and the payer signature, and the second major side including the payee endorsement and the barcode.

In Example 16, the method of any one or more of Examples 11-15 optionally further includes that the payer check data further includes a memo field, and further includes receiving memo text in the memo field.

In Example 17, the method of any one or more of Examples 11-16 optionally further includes generating a blank bank check facsimile based on the check image data.

In Example 18, the method of any one or more of Examples 11-17 optionally further includes that the issuer check data includes an account number associated with the check and further includes displaying, on the blank bank check facsimile, a dummy account number different than the account number.

In Example 19, the method of any one or more of Examples 11-18 optionally further includes including a personalized image in the check image data.

In Example 20, the method of any one or more of Examples 11-19 optionally further includes that at least one of the issuer data tag and the payer data tag further includes a service digital signature.

In Example 21, a system may include an issuer platform, including an electronic storage configured to store data tags related to a virtual check blank, including an issuer data tag, the issuer data tag including: issuer check data and an issuer digital signature and check image data configured to generate an image related to the virtual check blank and at least some of the data tags. The issuer platform further includes a network interface configured to transmit the data tags and the check image data to a payer platform. The virtual check blank is configured to be modified by a payer in a transaction at the payer platform, wherein the virtual check blank is configured to add a payer data tag of the data tags, the payer data tag including: the issuer data tag, payer check data, a payer digital signature.

In Example 22, the system of Example 21 optionally further includes an additional platform, coupled to the issuer platform, corresponding to at least one addition party to the transaction, wherein the virtual check blank is further configured to be modified by the at least one additional party to the transaction at the additional platform, wherein the virtual check blank is configured to add a new data tag for each additional party to the transaction, the new data tag including: each previously included data tag, additional party check data and an additional party digital signature.

In Example 23, the system of any one or more of Examples 21 and 22 optionally further includes that the additional platform includes a payee platform.

In Example 24, the system of any one or more of Examples 21-23 optionally further includes a processor, coupled to the electronic storage, configured to generate a bank check facsimile based on the check image data and the data tags and a user interface, coupled to the processor, configured to display the blank check facsimile, wherein the blank check facsimile includes a check amount, a date, a payer signature, a payee endorsement, and a barcode comprising at least some of the issuer check data and the payer check data, the issuer digital signature, the payer digital signature, and a payee digital signature.

In Example 25, the system of any one or more of Examples 21-24 optionally further includes that the bank check facsimile has a first major side and a second major side, the first major side including the check amount, the date, and the payer signature, and the second major side including the payee endorsement and the barcode.

In Example 26, the system of any one or more of Examples 21-25 optionally further includes a user interface and that the payer check data further includes a memo field configured to receive memo text.

In Example 27, the system of any one or more of Examples 21-26 optionally further includes a processor, coupled to the electronic storage, configured to generate a blank bank check facsimile based, at least in part, on the check image data.

In Example 28, the system of any one or more of Examples 21-27 optionally further includes that the issuer check data includes an account number associated with the check and wherein the check image data is configured to display, on the blank bank check facsimile, a dummy account number different than the account number.

In Example 29, the system of any one or more of Examples 21-28 optionally further includes that the check image data includes a personalized image.

In Example 30, the system of any one or more of Examples 21-29 optionally further includes that at least one of the issuer data tag and the payer data tag further includes a service digital signature.

In Example 31, the system of any one or more of Examples 21-29 optionally further includes the payer platform.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1000), such that the instructions, when executed by one or more processors of the machine (e.g., processor 1002), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. (canceled)

2. A system, comprising:
a payer platform, comprising:
a user interface
a processor;
a network interface; and
a non-transitory computer readable medium comprising instructions which, when implemented by the processor, cause the processor to perform operations comprising:
receive, via the network interface, a data structure from an issuer platform, the data structure comprising:
an issuer data tag, the issuer data tag including an issuer data and an issuer digital signature; and
image data to generate a legal document related to the data structure and the issuer data tag; and
receive, via the user interface, user data for inclusion in the data structure;
create a data tag, comprising:
the data structure;
the user data;
a user digital signature; and
a service digital signature from the issuer platform;
wherein the image data is further configured to present the data structure and the user data as the legal document;
transmit the data tag to a payee platform, wherein the data tag is configured to be modified with a payee digital signature for transmission to a deposit service.

3. The system of claim 2, wherein the data tag is further configured to iteratively add additional user data from third party recipients of the data tag.

4. The system of claim 3, wherein the data tag is configured to maintain the data structure, the user data, and the service digital signature as the additional user data is added to the data tag.

5. The system of claim 2, wherein the legal document is a bank check.

6. The system of claim 2, wherein the computer readable medium further comprises instructions that cause the processor generate a blank document facsimile based, at least in part, on the image data; the black document facsimile configured to be printed as the legal document.

7. The system of claim 6, wherein the blank document facsimile comprises a blank for a payee to endorse the legal document.

8. The system of claim 6, wherein the blank document facsimile comprises a personalized image associated with the user different than a signature, the issuer digital signature, and the payer digital signature.

9. A payer platform, comprising:
a user interface
a processor;
a network interface; and
a non-transitory computer readable medium comprising instructions which, when implemented by the processor, cause the processor to perform operations comprising:
receive, via the network interface, a data structure from an issuer platform, the data structure comprising:
an issuer data tag, the issuer data tag including an issuer data and an issuer digital signature; and
image data to generate a legal document related to the data structure and the issuer data tag; and
receive, via the user interface, user data for inclusion in the data structure;
create a data tag, comprising:
the data structure;
the user data;
a user digital signature; and
a service digital signature from the issuer platform;
wherein the image data is further configured to present the data structure and the user data as the legal document;
transmit the data tag to a payee platform, wherein the data tag is configured to be modified with a payee digital signature for transmission to a deposit service.

10. The payer platform of claim 9, wherein the data tag is further configured to iteratively add additional user data from third party recipients of the data tag.

11. The payer platform of claim 10, wherein the data tag is configured to maintain the data structure, the user data, and the service digital signature as the additional user data is added to the data tag.

12. The payer platform of claim 9, wherein the legal document is a bank check.

13. The payer platform of claim 9, wherein the computer readable medium further comprises instructions that cause the processor generate a blank document facsimile based, at least in part, on the image data, the black document facsimile configured to be printed as the legal document.

14. The payer platform of claim 13, wherein the blank document facsimile comprises a blank for a payee to endorse the legal document.

15. The payer platform of claim 13, wherein the blank document facsimile comprises a personalized image associated with the user different than a signature, the issuer digital signature, and the payer digital signature.

16. A non-transitory computer readable medium, comprising instructions which, when implemented by a processor; cause the processor to perform operations comprising:
receive, via a network interface, a data structure from an issuer platform; the data structure comprising:
an issuer data tag, the issuer data tag including an issuer data and an issuer digital signature; and
image data to generate a legal document related to the data structure and the issuer data tag; and
receive; via a user interface, user data for inclusion in the data structure;
create a data tag, comprising:
the data structure;
the user data;
a user digital signature; and
a service digital signature from the issuer platform;
wherein the image data is further configured to present the data structure and the user data as the legal document;
transmit the data tag to a payee platform, wherein the data tag is configured to be modified with a payee digital signature for transmission to a deposit service.

17. The computer readable medium of claim 16, wherein the data tag is further configured to iteratively add additional user data from third party recipients of the data tag.

18. The computer readable medium of claim 17, wherein the data tag is configured to maintain the data structure, the user data, and the service digital signature as the additional user data is added to the data tag.

19. The computer readable medium of claim 16, wherein the legal document is a bank check.

20. The computer readable medium of claim 16, further comprises instructions that cause the processor generate a blank document facsimile based, at least in part, on the image data, the black document facsimile configured to be printed as the legal document.

21. The computer readable medium of claim 20, wherein the blank document facsimile comprises a blank for a payee to endorse the legal document.
